(19) United States
(12) Patent Application Publication
(10) Pub. No.: US 2005/0279687 A1
(43) Pub. Date: Dec. 22, 2005

(54) Pressurized gas-water mixing device

(76) Inventor: Maxwell Hsu, Chung-Li (TW)

Correspondence Address: Yi-Wen Tseng, 4331 Stevens Battle Lane, Fairfax, VA, 22033, US

(21) Appl. No.: 10/871,563

(22) Filed: Jun. 21, 2004

(51) Int. Cl. C02F 1/78

(52) U.S. Cl. 210/192

(57) ABSTRACT

A pressurized gas-water mixing device for a multifunctional oxygenated water machine includes a hollow main body, a water collecting device and a water level detecting device. The main body includes a lower cylindrical container and an upper cylindrical container, and has a water inlet and a gas inlet both formed on the upper cylindrical container to respectively receive input water and ozone gas for mixing and a water outlet formed on the lower cylindrical container to output produced ozonated water. The water level detecting device installed in the main body is to maintain a suitable amount of ozonated water stored in the lower cylinder container; thereby, the consumer can conveniently obtain high concentration electrolised ozonated water or super oxygenated electrolised ozonated water from the multifunctional oxygenated water machine.

### BACKGROUND OF THE INVENTION

The present invention relates in general to a pressurized gas-water mixing device, and more particularly, to a pressurized gas-water mixer which is utilized in a multifunctional oxygenated water machine in order to well mix water and ozone gas to generate ozonated water.

Most drinking water machine utilize several pre-filters to remove the solid sediments from the water, then use a reverse osmosis filter to further remove other impurities, and finally use a post-filter to remove any strange odor from the water. Water that has gone through this process becomes safe and potable and is referred to as pure water. However, there is a problem that arises from this kind of filtering. This problem arises because the filtering process skims out both dirty particles and organic materials. The skimmed out organic material gradually accumulates with usage and facilitates the growth of unwanted bacteria in the filters. In order to avoid the health effects of the unwanted bacteria the consumer is forced to change the filters frequently. If the consumer does not change the filters frequently the bacteria density in the water produced will exceed the standard allowed for potable water.

Furthermore, even though the container is a closed space it is still highly probable that the container will become a virtual nirvana for bacteria. The water delivery outlet closest to the container is the most vulnerable to contamination by bacteria, but this is by no means the only site of potential contamination. This is because once the water delivery outlet closest to the container is contaminated, the bacteria will likely migrate to the rear of the container. There is, therefore, a need to kill the bacteria in the container.

In order to kill the bacteria in the container an ozone generator is installed in an ozonated water producer. The Ozone produced from this ozone generator will dissolve into the water producing ozonated water. This ozonated water will then effectively suppress the growth of the unwanted bacteria. However, the conventional ozonated water producer requires a longer period of time in order for it to dissolve the ozone into its pure water. Because of the longer period of time required by the conventional ozonated water producer, it could not produce ozonated water quickly enough for the consumer; the time required by the conventional ozonated water producer made its use inconvenient to consumers.

### BRIEF SUMMARY OF THE INVENTION

The present invention provides a pressurized gas-water mixing device for a multifunctional oxygenated water machine in order to well mix the water and the ozone gas to generate ozonated water.

The pressurized gas-water mixing device provided by the present invention includes a hollow main body formed by screwing a lower cylindrical container to an upper cylindrical container, a water inlet and a gas inlet both formed on the upper cylindrical container to respectively receive input water and ozone gas for mixing, a water outlet to output produced ozonated water, and a water level detecting device installed in the main body to maintain a suitable amount of ozonated water stored in the lower cylinder container. When the water level of the ozonated water stored exceeds the high water level, the high water level sensor will send a signal out to request the multifunctional oxygenated water machine to stop generating ozonated water. When the water level of the ozonated water stored drops below the low water level, the low water level sensor will send a signal out to request the multifunctional oxygenated water machine to generate more ozonated water.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These as well as other features of the present invention will become more apparent upon reference to the drawings therein:

FIG. 1 is a system diagram of a multifunctional oxygenated water machine.

FIG. 2 is a cross-sectional view of a pressurized gas-water mixing device in accordance with the present invention.

FIG. 3 illustrates the operation of the pressurized gas-water mixing device of the present invention.

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

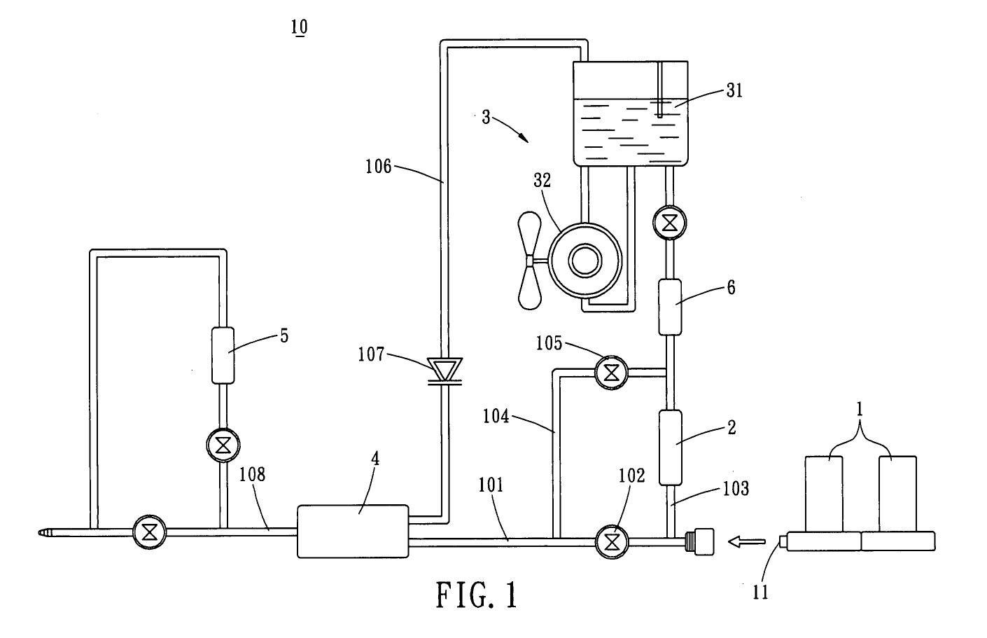

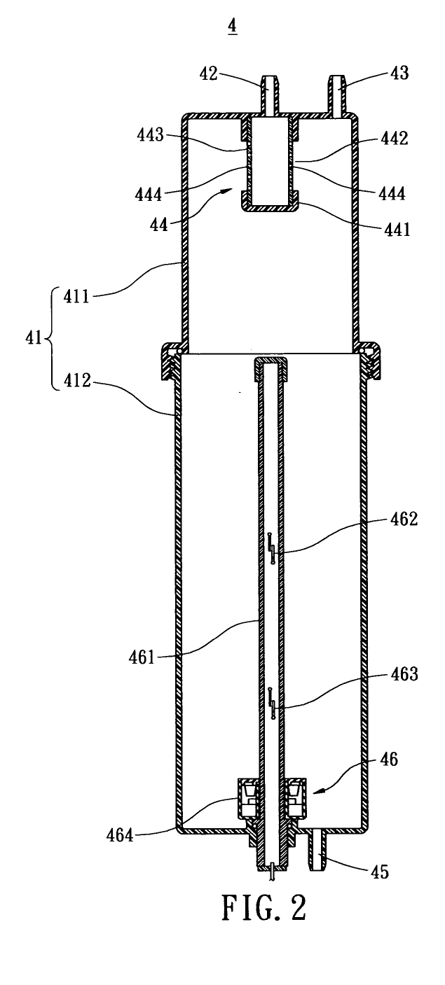

Referring to FIG. 1, a system diagram of a multifunctional oxygenated water machine 10 is shown. The multifunctional oxygenated water machine includes a pre-filter 1, a clean water generator 2, an ozone gas generator 3, a pressurized gas-water mixing device 4, a restorer 5, and a pure water generator 6. Before directing to the multifunctional oxygenated water machine, the source water flows into the pre-filter 1. The pre-filter 1 contains a 5 μmm filter cartridge and a ceramic filter cartridge, which can effectively filter out impurities, planktons, chlorides, and most bacteria and viruses. The water outlet 11 of the pre-filter 1 connects to the water inlet 42, as shown in FIG. 2, of the pressurized gas-water mixing device 4 via a first water conveying pipeline 101. A solenoid valve 102 installed in the first water conveying pipeline 101 controls the conveying of the preliminary clean water. A second water-conveying pipeline 103 connects to the first water conveying pipeline 101 at a location before the solenoid valve 102. The clean water generator 2, installed in the second water-conveying pipeline 103, contains a filter cartridge with copper ions, zinc ions, and activated carbons; it can effectively filter out various heavy metal elements, inorganic materials and chlorides. A third water-conveying pipeline 104 conveys the clean water generated by the clean water generator 2 to the pressurized gas-water mixing device 4. The inlet of the third water-conveying pipeline 104 connects to the second water-conveying pipeline 103 at a location between the clean water generator 2 and the pure water generator 6. The outlet of the third water-conveying pipeline 104 connects to the first water conveying pipeline 101 at a location between the solenoid valve 102 and the pressurized gas-water mixing device 4. A solenoid valve 105 is installed in the third water-conveying pipeline 104 to control the conveying of clean water. Thereby, by controlling the solenoid valve 102 and the solenoid valve 105, the water provided to the pressurized gas-water mixing device 4 can be either the preliminary clean water coming directly from the pre-filter 1 or the clean water passing through both the pre-filter 1 and the clean water generator 2.

The clean water generated by the clean water generator 2 can also be directed to the pure water generator 6. The pure water generator 6, its inlet connecting to the water-conveying pipeline 103, its outlet connecting to a pure water tank 31 of the ozone gas generator 3 through a pipeline with a control valve, contains a filter cartridge with ion exchange resins. It transforms clear water generated by the clean water generator 2 into pure water that the ozone gas generator 3 needs. The ozone gas generator 3 includes the pure water tank 31 and an ozone generator 32 which reacts with pure water and produces a mixture of ozone, oxygen, and water. The mixture of ozone, oxygen, and water is directed back to the pure water tank 31 via a pipeline. The pure water tank outputs ozone gas to the pressurized gas-water mixing device 4 via a gas pipeline 106 in which a check valve 107 is installed.

Referring to the FIG. 2, a cross sectional view of a pressurized gas-water mixing device in accordance with the present invention is shown. The pressurized gas-water mixing device 4 includes a hollow main body 41 formed by screwing a lower cylindrical container 412 to an upper cylindrical container 411, a water inlet 42, a gas inlet 43, a water collecting device 44, a water outlet 45, and a water level detecting device 46. The water inlet 42, connecting to the first water conveying pipeline 101, provides with either the preliminary clean water coming directly from the pre-filter 1 or the clean water passing through both the pre-filter 1 and the clean water generator 2 to the main body 41.

The water collecting device 44, installed at the top inner surface of the upper cylindrical container 411, includes a fixed mount 441 which has an opening 442 formed, a cylinder 443 with at least one large water spraying hole or a plurality of small spraying holes 444 installed inside the fixed mount 441. When the water flows into the cylinder 443 from the water inlet 42, these holes 444 form the water output holes of the water collecting device 44 and allow incoming water spraying against the inner wall of the upper cylindrical container 411.

The water level detecting device 46 is provided to maintain a suitable amount of ozonated water stored in the lower cylinder container 412 for immediate use by the consumer. The water level detecting device 46, located inside the lower cylindrical container 412, includes a hollow cylinder 461, a high water level sensor 462 and a low water level sensor 463 both fixed inside the hollow cylinder 461, and a floating device 464 sleeved around the hollow cylinder 461 in which a magnet is incorporated to provide electromagnetic induction. When the floating device 464 floats up above the high water level, the high water level sensor 462 senses the magnetism and then sends a signal out to request the multifunctional oxygenated water machine 10 to stop generating water. When the floating device 464 drops down below the low water level, the low water level sensor 463 senses the magnetism and then sends a signal out to request the multifunctional oxygenated water machine 10 to generate more ozonated water. Thereby, the pressurized gas-water mixing device 4 maintains an adequate water level and can consistently provide the high concentration electrolised ozonated water or the super oxygenated electrolised ozonated water.

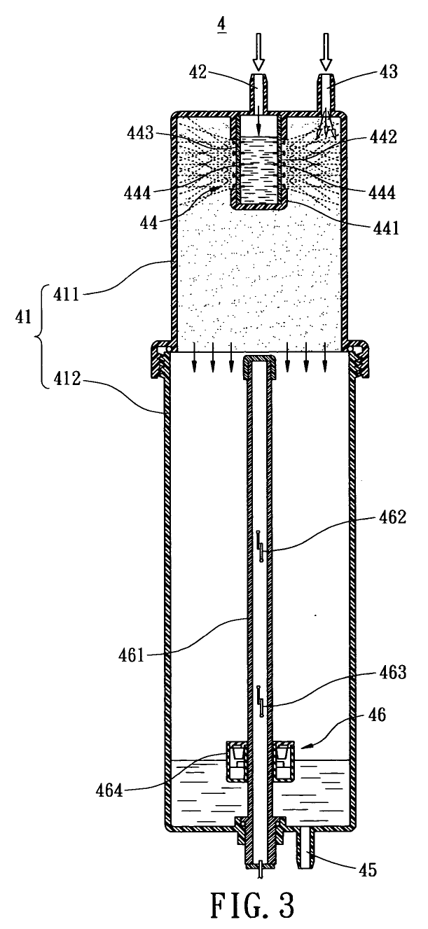

Referring to FIG. 3, if the preliminary clean water directly from the pre-filter 1 is transported to the pressurized gas-water mixing device 4, the input water first enters the cylinder 443 of the water collecting device 44, further passes through the water output holes 444 of the cylinder 443, and then sprays in a foggy style against the inner wall of the upper cylindrical container 411. When the premilinary clean water is sprayed out from the water output holes, a foggy eddy will be produced. Many currents flowing from the different water output holes will collide with each other, neutralizing and mixing with ozone gas. This mixing will further generate high concentration electrolised ozonated water which will be stored in the lower cylindrical container 412 for immediate use by the consumer.

Furthermore, if the clean water from the clean water generator 2 is transported to the pressurized gas-water mixing device 4, similarly the input water first enters the cylinder 443 of the water collecting device 44, further passes through the water output holes 444 of the cylinder 443, and then sprays in a foggy style against the inner wall of the upper cylindrical container 411. When the clean water is sprayed out from the water output holes, a foggy eddy will be produced. Many currents flowing from the different water output holes will collide with each other, neutralizing and mixing with ozone gas. This mixing will further generate super oxygenated electrolised ozonated water which will be stored in the lower cylindrical container 412 for immediate use by the consumer.

Thereby, the pressurized gas-water mixer of the present invention for a multifunctional oxygenated water machine is provided to well mix the input water and the ozone gas to generate the high concentration electrolised ozonated water or the super oxygenated electrolised ozonated water.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

1. A pressurized gas-water mixing device for a multifunctional oxygenated water machine, comprising:
a hollow main body having a water inlet connected to a water-conveying pipeline for receiving input water, a gas inlet connected to a gas-conveying pipeline for receiving ozone gas, and a water outlet for outputting ozonated water mixed by the input water and the ozone gas;
a water collecting device to collect the input water and spray the input water to mix with the ozone gas; and
a water level detecting device to maintain a suitable amount of ozonated water stored in the main body.

2. The pressurized gas-water mixing device of claim 1, wherein the hollow main body further comprises a lower cylindrical container having the water outlet and an upper cylindrical container having the water inlet and the gas inlet.

3. The pressurized gas-water mixing device of claim 1, wherein the water collecting device further comprises a fixed mount having an opening, and a cylinder having a plurality of spraying holes installed inside the fixed mount.

4. The pressurized gas-water mixing device of claim 1, wherein the water level detecting device further comprises a hollow cylinder, a high water level sensor and a low water level sensor both fixed inside the hollow cylinder, and a floating device sleeved around the hollow cylinder in which a magnet is incorporated to provide electromagnetic induction.
